(19) United States
(12) Patent Application Publication
(10) Pub. No.: US 2006/0096593 A1
(43) Pub. Date: May 11, 2006

(54) Protective garment equipped to maintain positive gas pressure in space between protective garment and inner clothes worn by wearer

(76) Inventors: William L. Grilliot, Dayton, OH (US); Mary I. Grilliot, Dayton, OH (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/985,391

(22) Filed: Nov. 11, 2004

(51) Int. Cl. A62B 17/00

(52) U.S. Cl. 128/201.29

(57) ABSTRACT

A protective garment, such as a protective coat, for a wearer who is a firefighter or an emergency rescue worker and who carries a self-contained breathing apparatus including a supply of compressed air, a face mask, which is arranged to intake air supplied by the supply for the wearer to breathe, is equipped to direct air supplied by the supply and/or air exhaled by the wearer, so as to maintain positive air pressure within a space between the protective garment and inner clothes where worn by the wearer within the protective garment and between the protective garment and bare skin of the wearer where such skin is not covered by inner clothes being worn by the wearer within the protective garment. The space is vented at edges of the protective garment.

### TECHNICAL FIELD OF THE INVENTION

This invention pertains to a protective garment, which may comprise an outer shell and a lining system comprising a liner or liners, for a firefighter or an emergency rescue worker. This invention contemplates that the protective garment is equipped to maintain positive gas pressure in a space between the protective garment and inner clothes worn by the firefighter or the emergency rescue worker.

### BACKGROUND OF THE INVENTION

As disclosed in U.S. Pat. No. 5,572,991, the disclosure of which is incorporated herein by reference, a protective garment for a firefighter is worn with a self-contained breathing apparatus (SCBA) having a air tank and having a face mask, from which exhaled air is delivered to a space between adjacent layers of the protective garment, so as to increase the thermal protective performance (TPP) of the protective garment. The space is vented through openings provided between adjacent layers of the protective garment.

As disclosed therein, fresh air from an air tank of the self-contained breathing apparatus or fresh air or another gas, such as carbon dioxide, from a separate cannister can be also delivered to the space, either, via a restricted orifice allowing fresh air to bleed into the space, or rapidly via a valve, which is closed normally but which the firefighter can open, via a pull ring, when the firefighter is exposed to extreme heat.

### SUMMARY OF THE INVENTION

Broadly, this invention provides, for a wearer who is a firefighter or an emergency rescue worker, a protective garment, such as a protective coat, protective trousers, protective overalls, or protective coveralls, is equipped with means for maintaining positive gas pressure within a space between the protective garment and inner clothes where worn by the wearer within the protective garment and between the protective garment and bare skin of the wearer where said skin is not covered by inner clothes being worn by the wearer within the protective garment. Positive air pressure maintained within the space not only increases the thermal protective performance of the protective garment but also inhibits ingress of foreign gaseous and particulate materials, which may be potentially hazardous.

In one contemplated embodiment, if the wearer carries a supply of compressed gas, such as compressed air or compressed carbon dioxide, the protective garment is equipped with means for directing compressed gas from the supply so as to maintain positive gas pressure within a space between the protective garment and inner clothes where worn by the wearer within the protective garment and between the protective garment and bare skin of the wearer where inner clothes are not being worn within the protective garment.

In another contemplated embodiment, if the wearer carries a self-contained breathing apparatus including a supply of compressed air and including a face mask, which is arranged to intake air supplied by the supply for the wearer to breathe and to expel air exhaled by the wearer, the protective garment is equipped with means for directing air exhaled by the wearer so as to maintain positive air pressure within a space between the protective garment and inner clothes where worn by the wearer within the protective garment and between the protective garment and bare skin of the wearer where inner clothes are not being worn within the protective garment.

In another contemplated embodiment, if the wearer carries a self-contained breathing apparatus including a supply of compressed air and including a face mask, which is arranged to intake air supplied by the supply for the wearer to breathe and to expel air exhaled by the wearer, the protective garment is equipped with means for directing air supplied by the supply so as to maintain positive air pressure within a space between the protective garment and inner clothes where worn by the wearer within the protective garment and between the protective garment and bare skin of the wearer where said skin is not covered by inner clothes being worn by the wearer within the protective garment.

In another contemplated embodiment, if the wearer carries a self-contained breathing apparatus including a supply of compressed air and including a face mask, which is arranged to intake air supplied by the supply for the wearer to breathe and to expel air exhaled by the wearer, the protective garment is equipped with means for directing air supplied by the supply and air exhaled by the wearer so as to maintain positive air pressure within a space between the protective garment and inner clothes where worn by the wearer within the protective garment and between the protective garment and bare skin of the wearer where said skin is not covered by inner clothes being worn by the wearer within the protective garment.

If the protective garment comprises an outer shell and a lining system, which comprises a liner or liners, the space is defined between the lining system and inner clothes where worn by the wearer within the protective garment and between the lining system and bare skin of the wearer where said skin is not covered by inner clothes being worn by the wearer within the protective garment. Preferably, in each contemplated embodiment, the space is vented at edges of the protective garment.

### BRIEF DESCRIPTION OF THE DRAWINGS

FIG. 1 is a pictorial, front view of a firefighter wearing a self-contained breathing apparatus and wearing a protective coat embodying this invention.

FIG. 2, on a larger scale, is a fragmentary, sectional view taken along line 2-2 of FIG. 1, in a direction indicated by arrows. In the embodiment illustrated in FIGS. 1 and 2, in which the protective coat has a lining system comprising a liner or liners, the protective coat is equipped with means for directing exhaled air into a space between the lining system and inner clothes worn by the firefighter.

FIG. 3, on a scale similar to the scale of FIG. 1, is a fragmentary, pictorial, side view of a firefighter wearing a self-contained breathing apparatus and wearing a protective coat embodying this invention. In the embodiment illustrated in FIG. 3, the protective coat is equipped with means for diverting some air from a supply tank of the self-contained breathing apparatus to the space described above. As illustrated in broken lines in FIG. 3, the protective coat may be also equipped with means, which are similar to means illustrated in FIGS. 1 and 2, for directing exhaled air into the space described above.

### DETAILED DESCRIPTION OF THE ILLUSTRATED EMBODIMENTS

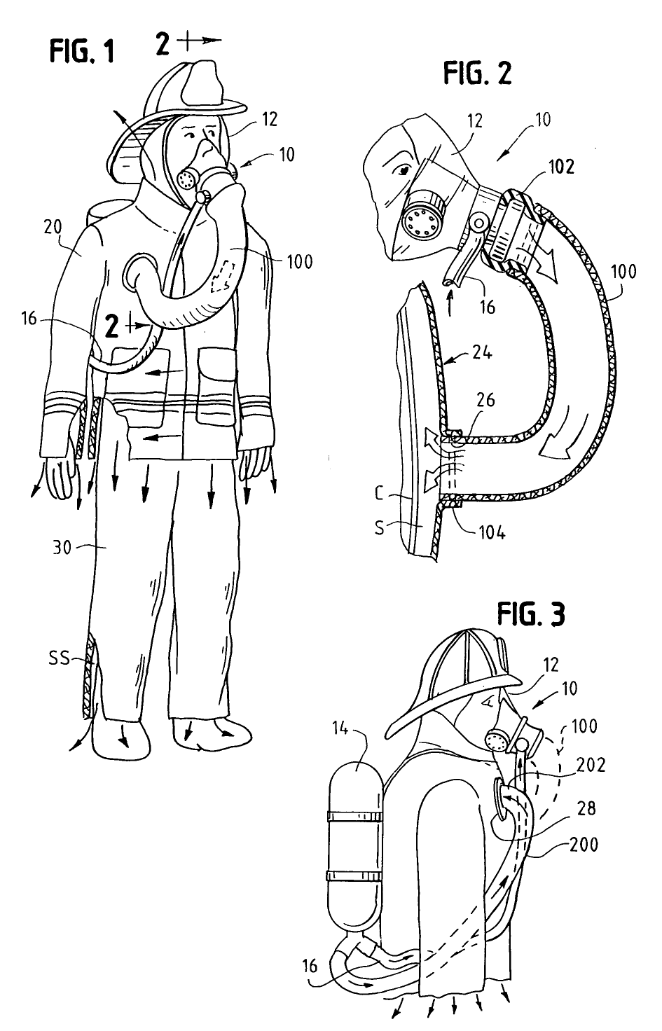

As illustrated in FIGS. 1, 2, and 3, a firefighter carries a self-contained breathing apparatus (SCBA) 10 and an ensemble of protective garments, which include a protective coat 20 and a pair of protective trousers 30. The self-contained breathing apparatus 10 comprises a face mask 12, an air tank 14 providing a supply of compressed air, a flexible hose 16 connecting the air tank 14 to the face mask 12 so as to direct air from the air tank 14 into the face mask 12, and a conventional arrangement of valves and regulators to control flow of fresh air supplied by the air tank 14 to the face mask 12 and to control flow of exhaled air from the face mask 12. The protective coat 20 comprises an outer shell 22 and a lining system 24, which comprises a liner or liners of a type or types used conventionally in protective garments for firefighters.

In the embodiment illustrated in FIGS. 2 and 3, a flexible hose 100 is coupled at its upper end 102 to the face mask 12, so as to receive exhaled air from the face mask 12. Moreover, the flexible hose 100 is coupled at its lower end 104 to an aperture 26 passing through the outer shell 22 and through the lining system 24, which is sewn to the outer shell around the aperture 26, so as to direct exhaled air received by the flexible hose 100 into a space S between the lining system 24 and inner clothes C worn by the firefighter within the protective coat 20 and between the lining system 24 and bare skin of the firefighter where said skin is not covered by inner clothes C worn by the firefighter within the protective coat 20. At its upper and lower ends 102, 104, the flexible hose 100 may be permanently or removably coupled, as and where noted.

In the embodiment illustrated in FIG. 3, a flexible hose 200 is coupled at its upper end 202 to an aperture 28, which is similar to the aperture 26, so as to direct air supplied by the air tank 14 into the space S. Moreover, the flexible hose 200 is coupled at its lower end 204 to the air tank 14, where the flexible hose 16 is coupled to the air tank 14, so as to supply air from the air tank 14 to the flexible hose 200, which directs air supplied by the air tank 14 into the space S. In an alternative embodiment, which is not illustrated, the firefighter carries a separate tank, which provides a supply of compressed gas, such as compressed air or compressed carbon dioxide, and to which the flexible hose 200 is coupled at its lower end 204, so as to supply compressed gas from the separate tank into the flexible hose 200, which directs air supplied by the separate tank into the space S. As illustrated in broken lines in FIG. 3, the flexible hose 100 may be also provided in the embodiment illustrated in FIG. 3 or in the alternative embodiment noted in the preceding sentence, so as to direct exhaled air into the space S.

Positive air pressure maintained within the space not only increases the thermal protective performance of the protective coat 20 but also inhibits ingress of foreign gaseous and particulate materials, which may be potentially hazardous. As indicated by arrows in FIG. 1 and in FIG. 3, the space S is vented at so-called “natural vents” at edges of the protective coat 20, e.g., at its cuff and collar edges, at its front edges where the protective coat 20 is closed, and at its lower edge.

Air from the air tank 14 or from the separate tank mentioned in the preceding paragraph may be similarly directed into a space SS similar to the space but defined between the pair of protective trousers 30 and inner clothes (not illustrated) worn by the firefighter within the protective trousers 30 and protective trousers 30 and bare skin of the firefighter where said skin is not covered by inner clothes worn by the firefighter within the protective trousers 30. As indicated by arrows in FIG. 3, the space SS is vented at so-called “natural vents” of the pair of protective trousers 30, e.g., at the lower edges of the legs of the pair of protective trousers 30.

1. For a wearer who is a firefighter or an emergency rescue worker, a protective garment equipped with means for maintaining positive gas pressure within a space between the protective garment and inner clothes where worn by the wearer within the protective garment and between the protective garment and bare skin of the wearer where said skin is not covered by inner clothes being worn by the wearer within the protective garment.

2. For a wearer who is a firefighter or an emergency rescue worker and who carries a supply of compressed gas, a protective garment equipped with means for directing gas from the supply so as to maintain positive gas pressure within a space between the protective garment and inner clothes where worn by the wearer within the protective garment and between the protective garment and bare skin of the wearer where said skin is not covered by inner clothes being worn by the wearer within the protective garment.

3. For a wearer who is a firefighter or an emergency rescue worker and who carries a self-contained breathing apparatus including a supply of compressed air and including a face mask, which is arranged to intake air supplied by the supply for the wearer to breathe and to expel air exhaled by the wearer, a protective garment equipped with means for directing air exhaled by the wearer so as to maintain positive air pressure within a space between the protective garment and inner clothes where worn by the wearer within the protective garment and between the protective garment and bare skin of the wearer where said skin is not covered by inner clothes being worn by the wearer within the protective garment.

4. For a wearer who is a firefighter or an emergency rescue worker and who carries a self-contained breathing apparatus including a supply of compressed air and including a face mask, which is arranged to intake air from the air supply for the wearer to breathe, a protective garment equipped with means for directing air supplied by the supply so as to maintain positive air pressure within a space between the protective garment and inner clothes where worn by the wearer within the protective garment and between the protective garment and bare skin of the wearer where said skin is not covered by inner clothes being worn by the wearer within the protective garment.

5. For a wearer who is a firefighter or an emergency rescue worker and who carries a self-contained breathing apparatus including an air supply and including a face mask, which is arranged to intake air from the air supply for the wearer to breathe and to expel air exhaled by the wearer, a protective garment equipped with means for directing air supplied by the supply and air exhaled by the wearer so as to maintain positive air pressure within a space between the protective garment and inner clothes where worn by the wearer within the protective garment and between the protective garment and bare skin of the wearer where said skin is not covered by inner clothes being worn by the wearer within the protective garment.

6. (canceled)

7. The protective garment of claim 1, 2, 3, 4, or 5 wherein the space is vented at edges of the protective garment.

8. (canceled)
